(19) United States
(12) Patent Application Publication
(10) Pub. No.: US 2016/0257601 A1
(43) Pub. Date: Sep. 8, 2016

(54) ELIMINATING THE NEED FOR A THIN-WALLED TUBE IN A POWDER-IN-TUBE (PIT) PROCESS

(71) Applicant: OFS Fitel, LLC, Norcross, GA (US)

(72) Inventor: Dennis J Trevor, Clinton, NJ (US)

(73) Assignee: OFS Fitel, LLC, Norcross, GA (US)

(21) Appl. No.: 15/086,886

(22) Filed: Mar. 31, 2016

Related U.S. Application Data
(63) Continuation-in-part of application No. 14/640,649, filed on Mar. 6, 2015.
Application No. 14/640,649 is a continuation-in-part of application No. 14/640,531, filed on Mar. 6, 2015.
Application No. 14/640,531 is a continuation-in-part of application No. 14/640,584, filed on Mar. 6, 2015.
Application No. 14/640,584 is a continuation-in-part of application No. 14/640,615, filed on Mar. 6, 2015.

(51) Int. Cl. C03B 37/012

(52) U.S. Cl. CPC C03B 37/01282; C03B 2201/06

(57) ABSTRACT

The need for thin-walled tubes or binders is eliminated in powder-in-tube preform manufacturing processes. This is done by using high-surface-area silica particles that consolidate at temperatures that are lower than a high-temperature mold.

### CROSS REFERENCE TO RELATED APPLICATIONS

This application is a continuation-in-part of U.S. patent application Ser. No. 14/640,649, filed on Mar. 6, 2015, having the title “Using Porous Grains in Powder-in-Tube (PIT) Process,” U.S. patent application Ser. No. 14/640,531, filed on Mar. 6, 2015, having the title “Using Silicon Tetrafluoride in Powder-in-Tube (PIT) Process,” U.S. patent application Ser. No. 14/640,584, filed on Mar. 6, 2015, having the title “Easy Removal of a Thin-Walled Tube in a Powder-in-Tube (PIT) Process,” and U.S. patent application Ser. No. 14/640,615, filed on Mar. 6, 2015, having the title “Manufacturing Irregular-Shaped Preforms,” all of which are incorporated by reference as if expressly set forth herein.

### BACKGROUND

1. Field of the Disclosure

The present disclosure relates generally to manufacturing and, more particularly, to manufacturing preforms.

2. Description of Related Arts

Optical fiber preforms possess properties that determine the characteristics of optical fibers that are eventually drawn from those preforms. The quality of an optical fiber correlates with the quality of materials that are used in manufacturing the preform from which the optical fiber is drawn. Furthermore, such preforms have almost universally been manufactured with a circular cross-section. As one can imagine, using higher-quality starting materials results in increased costs. In view of this, there are ongoing efforts to reduce the manufacturing costs of the preforms, and concurrently to improve the quality of the preforms.

### SUMMARY

Disclosed herein are various embodiments of systems and processes that employ porous silica grain in a preform manufacturing process. In some embodiments, the porous silica grains are purified, sintered, and consolidated.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an empty silica tube that has been sealed at the bottom such that it is gas permeable, but impermeable to grains.

FIG. 2 shows a core rod placed within the silica tube of FIG. 1.

FIG. 3 shows the silica tube of FIG. 2 being filled with silica grains.

FIG. 4 shows an enlarged view of the silica grains of FIG. 3.

FIG. 5 shows a mesoporous structure of one of the silica grains of FIG. 4.

FIG. 6 shows a purification process being applied after the silica-grain-filling process of FIG. 3.

FIG. 7 shows a vacuum being applied to the silica-grain-filled tube after the purification process shown in FIG. 6.

FIG. 8 shows sintering and condensation of the silica-grain-filled tube in the presence of the vacuum applied in FIG. 7.

### DETAILED DESCRIPTION OF THE EMBODIMENTS

Currently, optical fibers are designed with very stringent specifications in optical performance, mechanical strength, physical dimensions, and reliability. With increasing demands for bandwidth, these specifications continue to become increasingly stringent. In order for optical fibers to meet such stringent specifications, manufacturers employ exacting controls over the manufacturing process. While strict controls over the process contribute to the fiber quality, another factor that affects the quality of the fiber is the quality of the starting materials that are used to manufacture the optical fiber preforms from which the fibers are drawn. For example, if a preform contains impurities or defects, then those imperfections can result in degraded performance. Specifically, surface contamination and refractory particles, which act as stress centers during the fiber drawing process, affect the mechanical properties of optical fibers and contribute to fiber breakage. As such, much effort is devoted to using high-purity starting materials with minimal contaminants.

In one preform manufacturing process, known as a powder-in-tube (PIT) process, a silica tube is filled with silica powder and consolidated at high temperatures in the presence of a vacuum, thereby resulting in an optical fiber preform. Because conventional PIT processes typically use fully densified vitreous or crystalline silica, any refractory particle that is trapped within those densified material becomes a part of the preform. Consequently, those trapped refractory particles degrade the mechanical properties of the optical fiber that is eventually drawn from the preform. Thus, in order produce industrially-acceptable preforms, the conventional PIT processes use ultra-pure silica powder. In other words, because the resulting optical fiber inherits the impurities in the silica powder in conventional PIT processes, those processes strive to use silica of the highest purity as the starting materials. Unfortunately, ultra-pure silica is expensive. Hence, the cost of the resulting fiber is directly traceable to the cost of the silica starting materials.

Another drawback in the conventional PIT process is that it typically requires a thin-walled tube or a binder to hold coarse grains together for casting or pressing until sintering can take over at elevated temperatures. Unfortunately, these binders cause problems. For example, binders need to be removed, can add contamination, or occupy space (thereby limiting the density of a resulting un-sintered body). Similarly, thin-walled tubes cause problems. For example, the thin-walled tubes need to be removed or etched away during the final stages of preform fabrication.

The embodiments disclosed herein seek to eliminate the binder or the thin-walled tube in the PIT process. Specifically, the role of the binder is replaced, in part or completely, with high-surface-area silica particles that eventually become integrated with the final body, thereby eliminating the need for the thin-walled tube or the binder. This is because high-surface-area silica particles sinter to larger particles as well as to themselves at temperatures that are significantly lower than conventional consolidation temperatures and, also, below temperatures at which silica starts reacting with many mold materials (such as carbon, high-purity alumina, etc.). Again, using silica particles that eventually become integrated with the final body eliminates the need for binders or thin-walled tubes, since by sintering of the high-surface area particles at lower temperature than the softening temperature the body can be separated from the container and further processed.

Other benefits of the disclosed embodiments include the capability to produce irregular-shaped preforms without excess cost and waste associated with traditional methods that require grinding or acid etching to form the desired shape. By introducing an asymmetry or irregularity to the walls of the hollow tube, an irregular-shaped preform can be fabricated at a cost-savings, as compared to etching and grinding techniques. Consequently, this eliminates the need for further modification of the preform through grinding, acid etching, or other expensive and imperfect processes, which can negatively impact the fiber's performance.

As described in greater detail herein, using substantially homogeneous mesoporous silica grains provides a more economical approach to manufacturing optical fiber preforms. Having provided an overview of several embodiments, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

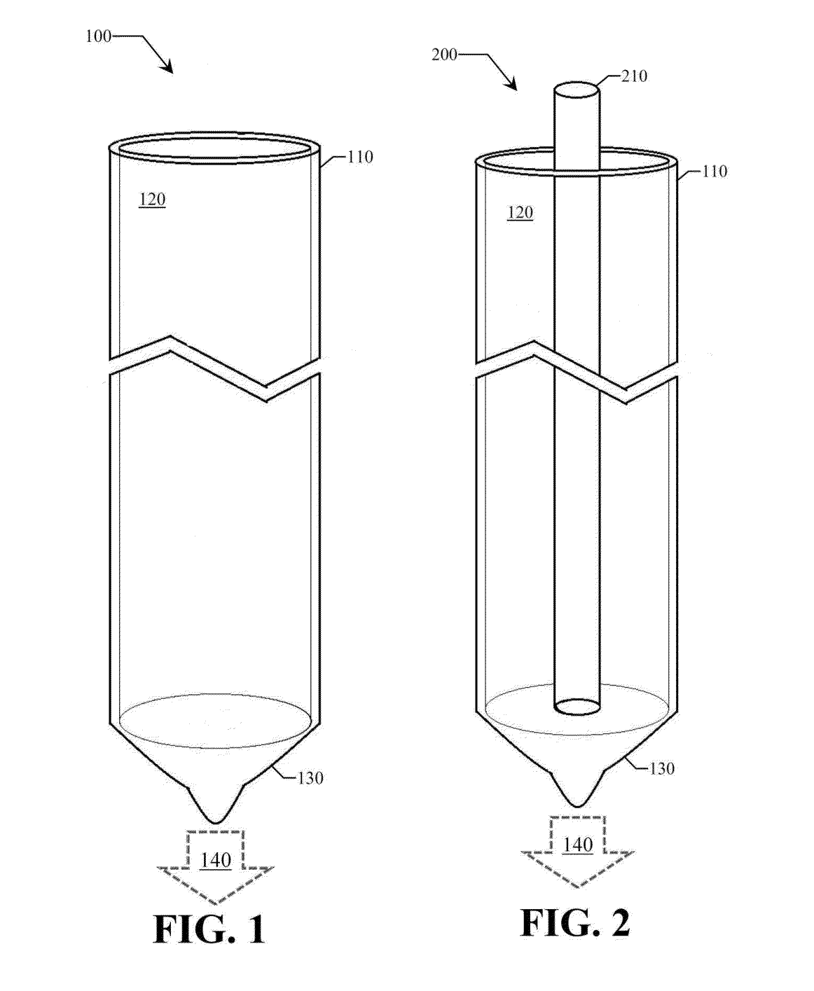

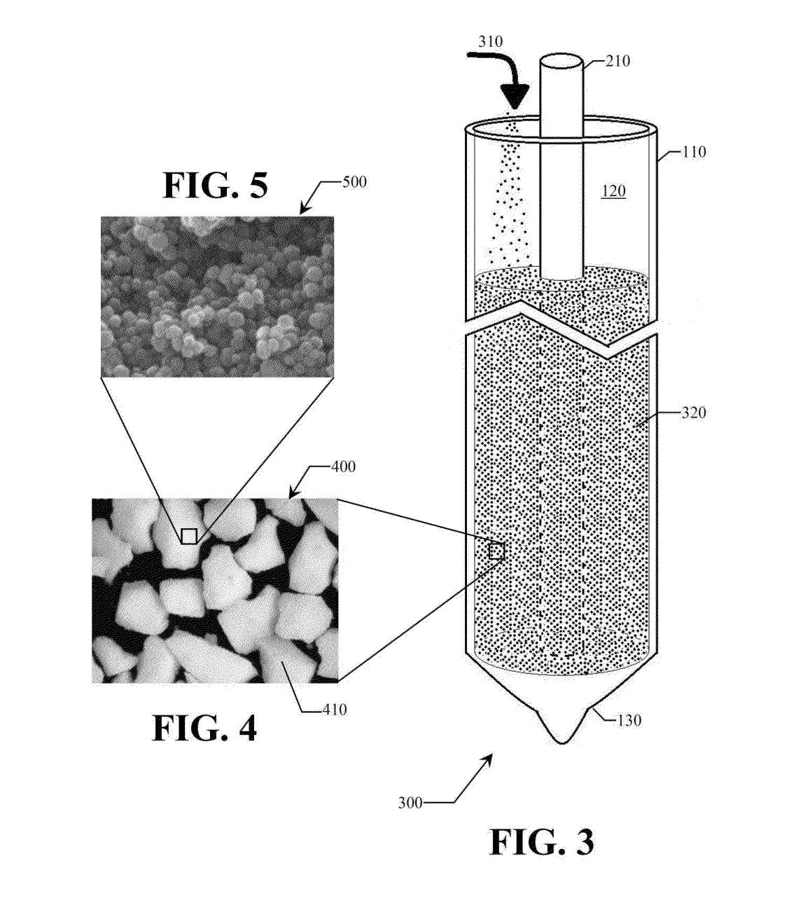

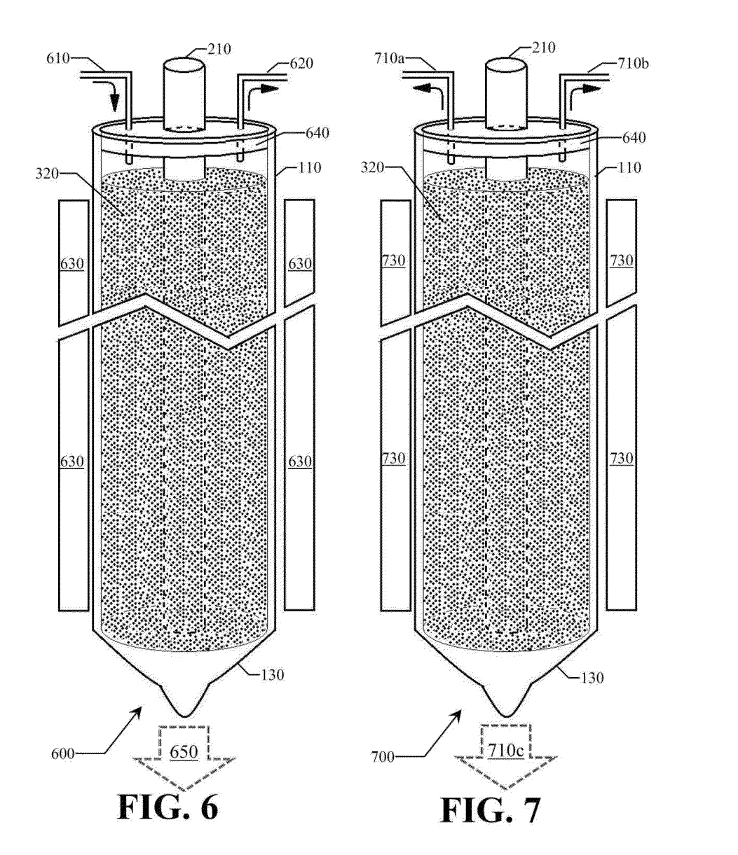

Generally, FIGS. 1 through 8 illustrate several embodiments of the inventive PIT preform-fabrication process, with embodiments that eliminate the need for a thin-walled tube or binder being discussed in greater detail with reference to FIGS. 3 and 7.

FIG. 1 shows one embodiment of a hollow tube 100 that is used in a powder-in-tube (PIT) preform manufacturing process. As shown in the embodiment of FIG. 1, the hollow tube 100 is a silica tube 110 with a cavity 120 and a grain-sealed bottom 130 (which is sealed to the grain but preferably permeable to gases). In other words, for preferred embodiments, the grain-sealed bottom 130 permits gas flow 140 but prohibits grains from escaping through the bottom 130. This silica tube 110 is preferably fabricated from fused quartz or silica. The quality of the silica tube 110 can vary, depending on whether the glass from the silica tube 110 that eventually becomes a part of the preform will be removed by etching or machining. For illustrative purposes, the silica tube 110 described herein is a thin-walled tube that is approximately 1.2 meters (m) in length with a wall thickness of approximately 2.5 millimeters (mm). Experiments have been successfully conducted using thin-walled tubes that have inner diameters that ranged from approximately 25 mm to approximately 90 mm. While these dimensions are provided to more clearly illustrate one embodiment of a PIT process, it should be appreciated that the dimensions of the silica tube 110 may be modified based on the manufacturing tolerances and preferences.

FIG. 2 shows a tube-and-core-rod setup 200, where a core rod 210 placed within the silica tube 110. Placing the core rod 210 in the silica tube 110, as shown in FIG. 2, permits manufacturing of optical fiber preforms that can be drawn into an optical fiber. Conversely, a thin-walled silica tube 110 without a core rod 210 can be used in manufacturing a silica rod that can be used for core material or jackets, for example, a rod-in-tube process. For illustrative purposes, the PIT processes described herein are implemented using the rod setup 200. However, it should be appreciated that similar PIT processes can be implemented with the hollow tube 100 in the absence of the core rod.

With the starting tubes and configurations of FIGS. 1 and 2 in mind, attention is turned to FIG. 3, which shows a tube-filling setup 300, where the silica tube 110 of FIG. 2 is filled with silica grains 310. For embodiments in which the need for a binder or a thin-walled tube is eliminated, the silica grains 310 comprise high-surface-area silica particles, which have a lower consolidation temperature than the temperature at which silica starts reacting with conventional mold materials (e.g., carbon, high-purity alumina, etc.).

As shown in FIG. 3, the thin-walled silica tube 110 has a grain-sealed bottom 130, which permits filling of the cavity 120 from the top of the silica tube 110. Since the embodiment of FIG. 3 includes a core rod 210, entering silica grain 310 fills the space in the silica tube 110 surrounding the core rod 210, and the silica grain 320 accumulates from the bottom upward. For some embodiments, a mild mechanical disruption can be introduced during the filling process to permit the settled silica grains 320 to achieve a random-close-packed density. In addition, the rod position can be examined and adjusted, for example, to center it in the outer tube, during the filling operation. The resulting configuration is random-close-packed silica grains 320 in the silica tube 110, and hence the name powder-in-tube (PIT).

Unlike conventional PIT processes that use dense fused vitreous or crystalline silica grains, the tube-filling setup of FIG. 3 uses mesoporous silica grains 410, which are shown in greater detail in enlarged view 400 of FIG. 4. In one preferred embodiment, the mesoporous silica grains 410 have a substantially monodisperse size distribution, meaning that the mesoporous silica grains 410 have a substantially uniform (or homogeneous) grain size. Since the purification time for the mesoporous silica grains 410 is directly proportional to the diffusion length of the contaminants that are being purged, a larger grain size results in a longer purification time, while a smaller grain size results in a correspondingly-shorter purification time. Also, if faster sintering is desired, then smaller pore and primary particle sizes are preferable, since smaller particles sinter faster than larger particles. In one preferred embodiment, approximately-250-micron-size mesoporous silica grains 410 comprising approximately 10 nm to 50 nm pores made of 50 nm fundamental particles are used as the starting materials for the disclosed PIT processes. However, it should be appreciated that the grain size can be varied as desired, with a preferred grain size being between approximately 2 microns and 550 microns.

It is worthwhile to note is that the random-close-packed density is the same irrespective of the grain size, as long as the grains are substantially homogeneous. As such, whether the grains are uniformly 25 microns, 70 microns, 150 microns, or 250 microns, as long as the size distribution is monodisperse, the packing density is substantially the same.

One way of manufacturing the substantially homogeneous mesoporous silica grains 320 is by using a sol-gel process. Since sol-gel processes are well-known in the art, only a truncated discussion of the process is provided herein to properly frame the inventive PIT processes. Within the sol-gel process, fumed silica is dispersed in water using an appropriately-small quantity of tetramethyl ammonium hydroxide. This dispersion is mixed under high-shear conditions and then centrifuged to remove particulates of higher density, typically comprising metals, metal oxides, and large particulates of comparable density, usually of incompletely dispersed silica agglomerates. The mixture is filtered again, but this time to remove dissolved gases and bubbles, and also to further remove particles up to the cut-off size that is relevant to fiber strength degradation. Thereafter, the mixture is formed into a solid material by optionally gelling, settling, or mechanically compacting. The solid form is dried, which results in a mesoporous silica cake. And, it is from this mesoporous silica cake that the mesoporous silica grains 320 are derived. Specifically, the dried cake is crushed and ground into a desired uniform grain size (e.g., 250-micron-size grains). At this point, the impurities in the dried gel include small amounts of water and organic species (a few percent by weight of each), a fraction of a percent surface hydroxyl, and parts-per-million (ppm) levels of metals and metal oxides. In other words, at this point, the mesoporous silica grains 320 still have impurities. However, as discussed below, those impurities can be removed during the disclosed PIT process.

A closer examination of the pore structure is helpful in understanding the purification mechanism in the disclosed PIT process. For this reason, FIG. 5 shows a pore structure 500 of one of the mesoporous silica grains 410. As shown in FIG. 5, the pores in the mesoporous silica grains 410 are connected to the surface of the grains. The connected porosity of the pore structure 500 provides a mechanism that allows impurities that are smaller than the pore size to diffuse to the surface of the silica grain with rapid access of reactive chemicals to promote this purification via removal or chemically transforming the impurities into benign components with respect to fiber performance. As noted earlier, if the grain size is sufficiently small to permit implementation of diffusion-based purification processes, then the mesoporous silica grains 410 can be purified during the PIT process, thereby ameliorating the need for ultra-pure silica as the starting materials. In other words, since the mesoporous structure permits purification, unlike the fully densified silica crystals in conventional PIT processes, the disclosed mesoporous structure results in a cost reduction when compared to the use of fully densified silica grain.

With this in mind, attention is turned to FIG. 6, which shows a purification setup 600 that is used to purify the mesoporous silica grains 320 that have filled the silica tube 110, as shown in FIG. 3. In the configuration of FIG. 6, an upper seal 640 is placed on the thin-walled silica tube 110, which, in conjunction with the grain-sealed bottom 130, creates a substantially closed environment within the silica tube 110. The mesoporous silica grains 320 are held within the closed environment. The upper seal 640 comprises two input ports (a first input port 610 and a second input port 620) through which chlorine, nitrogen, thionyl chlorine, and air are introduced into the closed environment. Since the grain-sealed bottom 130 is gas-permeable, in one preferred embodiment, any remaining water, organic species, surface hydroxyl, metals, metal oxides, and reaction products are expelled 650 from the closed environment through the grain-sealed bottom 130. The purification setup 600 also includes a heating element 630 (e.g., torch or furnace) that is used in the purification process. In an alternative embodiment, the second port 620 may be used in conjunction with the grain-sealed bottom 130 to expel the remaining water, organic species, surface hydroxyl, metals, metal oxides, and reaction products.

Before discussing the purification process, it is worthwhile to note another advantage of using mesoporous silica grains 320 with the input ports 610, 620. Namely, the pore structure 500 permits doping during the PIT process, and the input ports 610,620 provide a mechanism by which dopants can be introduced to the mesoporous silica grains 320. As one can see, the grain-sealed bottom 130 expels 650 excess dopants and permits regulation of pressure within the closed environment. For example, the final silica can be effectively doped using fluorine or chlorine introduced as SiF₄ or SiCl₄ respectively at temperatures and pressure after or during purification but before the mesoporous silica grain is consolidated. Other dopant sources, can be used if the vapor pressure is sufficient below silica sintering temperatures. These can include but not limited to rare earth or alkali chlorides. The doping level can be direct surface coverage on the high surface area silica component of the mesoporous material, which can be a few mole percent for high surface area reactive dopants like SiCl₄, and higher for dopants that further diffuse into the silica high surface area particles such as F. Dopants can also be included in the grain as a mixture of solids, oxides for example granulated glasses, GeO₂, B₂O₃, Al₂O₃, fluorides AlF₃, silicates Al₂SiO₅. This approach is limited by the ability of the dopant to withstand the purification of the mesoporous grain and consolidate without causing devitrification of the bulk silica. The dopant can be of high purity to reduce the need for extensive purification. Also the meso-posous silica can be made of high purity material or material that was previously purified before being used in this process. Another doping process is to use a Sol-Gel process to make chemically bonded mesoporous materials such as used for bulk glass doped with Ge in U.S. Pat. No. 6,443,977 or F doped in U.S. Pat. No. 6,223,563.

As for the purification process, in operation, once the mesoporous silica grains 320 are packed in the thin-walled tube 110, the purification setup 600 is heated to approximately 600 degrees Celsius (°C.) to remove residual water and organic species in an anaerobic environment followed by an oxidizing environment. Since those compounds are trapped in a mesoporous material 500, the heat causes those impurities to diffuse to the surface of the mesoporous silica grain 410 for eventual evacuation through the output vent. Since 600° C. is well below the melting point of silica, the mesoporous silica material 500 maintains its shape during this evacuation process.

Once the water and organic species are removed, chlorine is introduced into the closed environment through the input port 610, and the temperature of the heating element is raised to approximately 1000° C. At this temperature, the remaining water that is chemically bonded with the silica now reacts with the chlorine, thereby resulting in the dehydroxilation of the silica. The byproducts from the dehydroxilation process are expelled through the output vent 620.

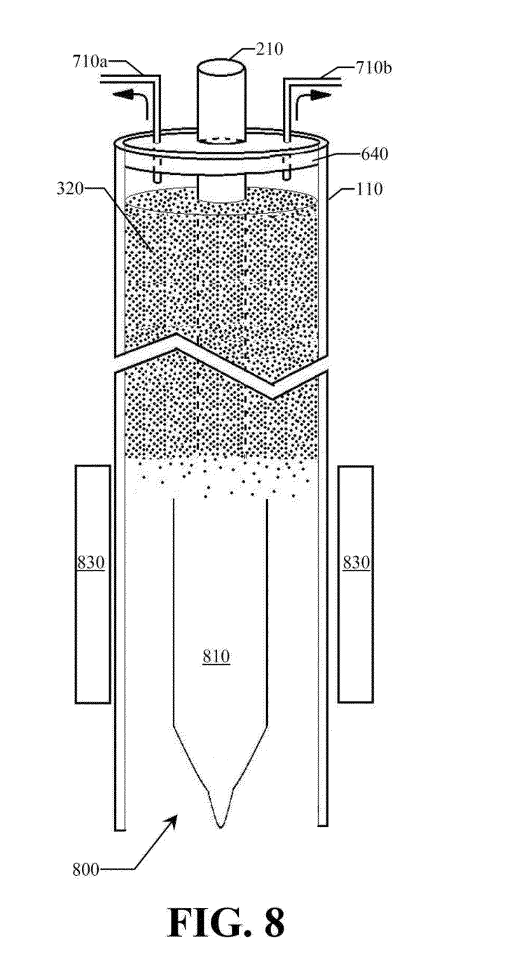

In the next purification step, metal and metal oxide refractories (such as zirconia and chromia) are removed or transformed in a nitrogen environment by introducing thionyl chloride into the closed environment via the input port 610, and increasing the temperature of the heating element 630 to approximately 700° C. for thionyl chloride and approximately 1250° C. for chlorine. The purification process yields a fully dehydroxilated, high-purity, mesoporous silica grain 320, which is ready for sintering and consolidation, which are discussed in greater detail with reference to FIGS. 7 and 8.

FIG. 7 shows a vacuum application setup 700 in which a vacuum is applied to the silica-grain-filled tube. The input ports 610, 620 (FIG. 6) now serve as vacuum ports 710a, 710b, along with the grain-sealed bottom 130 (now labeled as 710c). Thus, a vacuum can be drawn through these outlets 710a, 710b, 710c, thereby reducing the pressure within the silica tube 110. Here, the upper seal 640 provides a closed environment, thereby allowing for depressurization through the vacuum ports 710a, 710b, 710c. In one preferred embodiment, both upper vacuum ports 710a, 710b are sealed, and evacuation occurs through the grain-sealed bottom 710c, thereby avoiding disruption of the packed grain with a pressure gradient being established along the direction of gravity.

Since the mesoporous silica (due to its small fundamental particle size) has a higher surface-to-volume ratio than fully densified silica, the consolidation temperature of the mesoporous silica grains 320 is lower than the temperature at which the silica tube softens. This is even more pronounced with the introduction of high-surface-area silica particles, because these high-surface-area silica particles facilitate consolidation at lower temperatures, as noted above.

As shown in FIG. 8, given the proper combination of high temperatures (e.g., approximately 1450° C.) and vacuum, the mesoporous silica grains 320 sinter and shrink away from the silica tube 110. In other words, rather than collapsing concurrently with the silica grains 320, the silica tube 110 acts as a crucible in which the mesoporous silica grains 320 sinter without deforming the silica tube. This results in a high-purity, sufficiently densified silica body 810 that can be further consolidated or directly drawn (similar to other known vacuum sintered bodies) and a silica tube 110 that is reusable (rather than being consumed or integrated into the solid silica body 810 that eventually forms). The ability to sinter and consolidate with the reusable silica tube 110 (because of the high-temperature step, which could be as low as 1400° C.) results in a drawable preform. This process is also advantageous because it does not require use of Helium during the sintering process of the grain. However, it should be noted that, for some embodiments, Helium may still be employed when consolidating the silica.

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica particles, the disclosed processes use mesoporous silica grains that have a substantially monodisperse size distribution. Stated differently, mesoporous silica grains with substantially uniform grain size are used as the starting materials for the disclosed PIT processes. In one preferred embodiment, 150-micrometer-size mesoporous silica grains are used as the particular starting material.

As described with reference to FIGS. 1 through 8, the use of mesoporous silica grains 320 permits the application of purification processes that cannot be applied to fully densified silica crystals. Thus, the disclosed PIT process is not as restricted to the use of ultra-high-purity silica that is typically required for conventional PIT processes. Consequently, the disclosed PIT process provides a cost reduction that is typically not achievable in conventional processes for similar-quality optical fiber preforms. Additionally, the porosity of the mesoporous silica 500 permits doping during the PIT process, concurrent sintering of the mesoporous silica grains 320 with out the consolidation of the cruicible tube 110, and further cost reductions by using a single high-temperature sintering-and-consolidation step. Ultimately, the use of mesoporous silica grains 320 as the starting material for the disclosed PIT process no longer requires the manufacturer to use the highest-purity starting materials for preform fabrication but, rather, allows a lower-cost material to be purified to the necessary specifications, thereby reducing a large portion of the manufacturing costs.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, it should be understood that mesoporous means a porous structure in which the pores are connected to the surface of the grain. All such changes, modifications, and alterations should therefore be seen as within the scope of the disclosure.

What is claimed is:

1. A powder-in-tube preform manufacturing process, comprising:
sealing a silica tube with a grain-sealed bottom, the grain-sealed bottom being gas-permeable, the silica tube having a wall thickness of approximately 2.5 millimeters (mm), the silica tube having an inner diameter that is between approximately 25 mm to approximately 90 mm, the silica tube having a tube length of approximately 1.2 meters (m), the silica tube having a first melting temperature;
filling the silica tube with mesoporous silica grains and high-surface-area silica particles, the mesoporous silica grains being substantially monodisperse in size, the mesoporous silica grains being smaller than refractory particles, the high-surface-area silica particles having a second melting temperature, the second melting temperature being lower than the first melting temperature;
applying a vapor-phase purification process to the mesoporous silica grains, the vapor-phase purification process being applied at a temperature that is less than approximately 1300 degrees Celsius (° C.); and
sintering the mesoporous silica grains at a temperature that is greater than approximately 1400° C.

2. The process of claim 1, wherein the size of the mesoporous silica grain is between approximately 2 microns and approximately 550 microns.

3. The process of claim 2, wherein the size of the mesoporous silica grain is approximately 250 microns.

4. A preform manufacturing process, comprising:
filling a silica tube with silica grains, the silica grains comprising substantially homogeneous mesoporous silica particles, the silica grains further comprising high-surface-area silica particles;
applying a vapor-phase purification process to the silica grains; and
consolidating the silica grains.

5. The process of claim 4, the mesoporous silica particles having a grain size of approximately 250 microns.

6. The process of claim 4, the silica tube having a first melting temperature, high-surface-area silica particles having a second melting temperature, the second melting temperature being lower than the first melting temperature.

7. The process of claim 4, the step of applying the vapor-phase purification process comprising:
applying a purification temperature that is less than approximately 1300 degrees Celsius (°C.).

8. The process of claim 4, further comprising:
applying a vacuum to the silica tube to decrease the pressure within the silica tube.

9. The process of claim 8, further comprising:
sintering the mesoporous silica particles.

10. The process of claim 9, the sintering the mesoporous silica particles comprising:
sintering the mesoporous silica particles in the presence of the vacuum.

11. The process of claim 9, the sintering of the mesoporous silica particles comprising:
sintering the mesoporous silica particles at a temperature that is greater than approximately 1400° C.

12. A preform manufacturing system, comprising:
silica grains, comprising:
substantially homogeneous mesoporous silica particles; and
high-surface-area silica particles;
a silica tube holding the silica grains;
an input port to introduce gases into the silica tube;
an output vent to evacuate impurities from the silica tube; and
a heating element to heat the silica grains.

13. The system of claim 12, the mesoporous silica particles having a grain size of approximately 250 microns.

14. The system of claim 12, the heating element being a torch.

15. The system of claim 12, the heating element being a furnace.

16. The system of claim 12, the input port to further depressurize the silica tube.

17. The system of claim 12, the output vent to further depressurize the silica tube.

18. The system of claim 12, the silica tube having a first melting temperature, the high-surface-area silica particles having a second melting temperature, the second melting temperature being lower than the first melting temperature.

19. The system of claim 18, the silica tube having a wall thickness of approximately 2.5 millimeters.
